(19) United States
(12) Patent Application Publication
(10) Pub. No.: US 2016/0015008 A1
(43) Pub. Date: Jan. 21, 2016

(54) SUPPLEMENT PATTY DELIVERY SYSTEM

(71) Applicant: James Zane Bunderson, Deweyville, UT (US)

(72) Inventor: James Zane Bunderson, Deweyville, UT (US)

(21) Appl. No.: 14/736,214

(22) Filed: Jun. 10, 2015

Related U.S. Application Data
(60) Provisional application No. 62/010,190, filed on Jun. 10, 2014.

(51) Int. Cl. A01K 53/00

(52) U.S. Cl. CPC A01K 53/00

(57) ABSTRACT

For supplement patty delivery, an apparatus comprises a hopper, a distribution hose, and a power unit. The hopper comprises side walls with a slope angle in the range of 30 to 60 degrees, a bottom comprising an aperture with a minimum aperture dimension in the range of 8 to 16 inches, and a hopper connector in communication with the aperture. The power unit comprises an intake connector in physical communication with the hopper connector and a patty pump in physical communication with the distribution hose, wherein the intake connector removably connects the hopper connector to an input of the patty pump, and the distribution hose connects to an output of the patty pump.

### CROSS-REFERENCE TO RELATED APPLICATIONS

This application claims the benefit of U.S. Provisional Application No. 62/010,190 filed Jun. 10, 2014, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Present Disclosure

The subject matter disclosed herein relates to a delivery system and more particularly relates to a supplement patty delivery system.

2. Description of Related Art

Bee colonies are often fed a supplement patty. Delivering the supplement patties can be time consuming and/or labor intensive.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a side view drawing illustrating one embodiment of a supplement patty delivery system; and

FIG. 2 is a side view drawing illustrating one alternate embodiment of a supplement patty delivery system.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The description of elements in each figure may refer to elements of proceeding figures. Like numbers refer to like elements in all figures, including alternate embodiments of like elements.

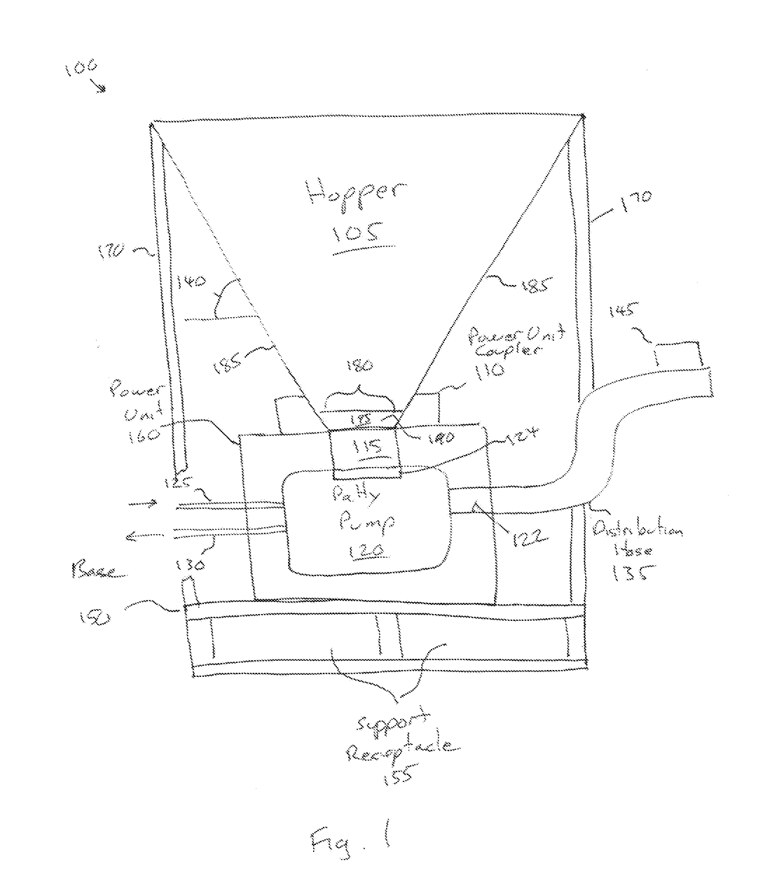

FIG. 1 is a side view drawing illustrating one embodiment of a supplement patty delivery system 100. The system 100 delivers supplement patties. In the depicted embodiment, the system 100 includes a hopper 105, a distribution hose 135, and the power unit 160.

In the past, supplement patties have been manually distributed to the beehives of bee colonies. The manual distribution of the supplement patties is labor intensive and time consuming. The embodiments described herein provide the hopper 105 that receive and hold supplement patties. The power unit 160 receives the supplement patties from the hopper 105 and pumps the supplement patties through the distribution hose 135, allowing the supplement patties to be rapidly distributed. As a result, the provision of the supplement patties is greatly accelerated.

The hopper 105 may be filled with supplement patties. A power unit coupler 110 may removably couple the power unit 160 to the hopper 105. The power unit coupler 110 may comprise one or more of clamps, fasteners, tongue and groove connectors, or combinations thereof.

The hopper 105 may be connected by supports 170 to a base 150. In one embodiment, the base 150 is configured as a pallet. The power unit 160 may rest on the base 150. Alternatively, the power unit 160 may be suspended from the power unit coupler 110. The base 150 may include one or more support receptacles 155. The support receptacles 155 may support the hopper 105 and/or the power unit 160 on a forklift arm.

The hopper 105 includes side walls 185. The side walls 185 may have a slope angle 140 in the range of 30 to 60 degrees. The hopper 105 further includes a bottom 190 with an aperture 180. In one embodiment, the aperture 180 has a minimum aperture diameter dimension in the range of 8 to 16 inches. The bottom 190 further comprises a hopper connector 195. Gravity may motivate supplement patties through the aperture 180 and the hopper connector 195.

The power unit 160 includes an intake connector 115 and a patty pump 120. The intake connector 115 may be in physical communication with the hopper connector 195. The intake connector 115 may removably connect the hopper connector 195 to an input 124 of the patty pump 120. The intake connector 115 may receive the supplement patties from the hopper connector 195. In addition, the intake connector 115 may provide the supplement patties to the input 124 of the patty pump 120. The distribution hose 135 may connects to an output 122 of the patty pump 120.

Gravity may motivate the supplement patties from the hopper connector 195 through the input connector 115 to the input 124 of the patty pump 120. The patty pump 120 motivates supplement patties through the distribution hose 135. In one embodiment, each supplement patty has a viscosity in the range of 100,000 to 300,000 centipose. Alternatively, each supplement patty may have a viscosity in the range of 50,000 to 500,000 centipose.

The patty pump 120 may be driven by a hydraulic input 125. The hydraulic input 125 may provide hydraulic fluid in the range of 13 to 16 gallon/minute at a pressure in the range of 2200 to 2800 pounds per square inch. A hydraulic output 130 may return the hydraulic fluid to a hydraulic fluid source. In one embodiment, the hydraulic input 125 is connected to the hydraulic supply of a forklift (not shown). Alternatively, the patty pump 120 may be electrically driven.

The distribution hose 135 may have a diameter the range of 1 to 4 inches . In one embodiment, the diameter of the distribution hose 135 is 2 inches. In the depicted embodiment, a hydraulic control 145 is disposed on the distribution hose 135. The hydraulic control 145 may drive the patty pump 120 in one of a forward direction and a reverse direction. In an alternative embodiment, the hydraulic control 145 is disposed in a forklift. In one embodiment, the control 145 is an electrical control.

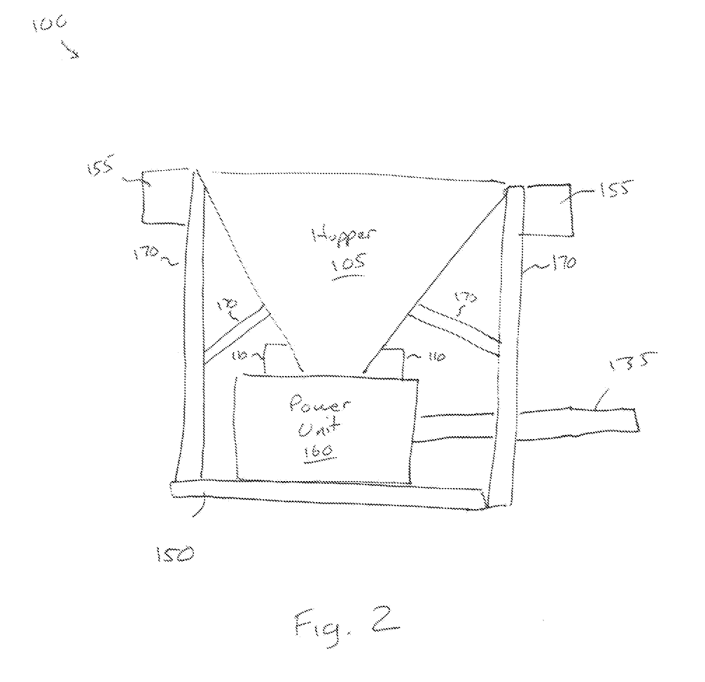

FIG. 2 is a side view drawing illustrating one alternate embodiment of a supplement patty delivery system 100. In the depicted embodiment, the support receptacles 155 are in physical communication with supports 170 and near the top of the hopper 105. Alternatively, the support receptacles 155 may be in physical communication with the hopper 105. In addition, the support receptacles 155 may be disposed near a midpoint of the hopper 105/power unit 160 combination.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a hopper comprising side walls with a slope angle in the range of 30 to 60 degrees, a bottom comprising an aperture with a minimum aperture dimension in the range of 8 to 16 inches, and a hopper connector in communication with the aperture;
a distribution hose; and
a power unit comprising an intake connector in physical communication with the hopper connector and a patty pump in physical communication with the distribution hose, wherein the intake connector removably connects the hopper connector to an input of the patty pump, and the distribution hose connects to an output of the patty pump.

2. The apparatus of claim 1, wherein gravity motivates a supplement patty from the hopper through hopper connector and the intake connector to the patty pump and the patty pump motivates the supplement patty through the distribution hose.

3. The apparatus of claim 2, wherein supplement patty has a viscosity in the range of 100,000 to 300,000 centipose.

4. The apparatus of claim 1, wherein patty pump is driven by a hydraulic input that provides hydraulic fluid in the range of 13 to 16 gallon/minute at a pressure in the range of 2200 to 2800 pounds per square inch.

5. The apparatus of claim 4, the apparatus further comprising a hydraulic control that drives the patty pump in one of a forward direction and a reverse direction.

6. The apparatus of claim 5, wherein the hydraulic control is disposed on the distribution hose.

7. The apparatus of claim 1, wherein the distribution hose has a diameter in the range of 1 to 4 inches.

8. The apparatus of claim 7, wherein the distribution hose has a diameter of 2 inch.

9. The apparatus of claim 1, the apparatus further comprising a power unit coupler that removably couples the power unit to the hopper.

10. The apparatus of claim 1, the hopper further comprising at least one support receptacle that supports the hopper on a forklift arm.
